(19) United States
(12) Patent Application Publication
(10) Pub. No.: US 2026/0245301 A1
(43) Pub. Date: Aug. 20, 2026

(54) EXTENDED REALITY QUALITY CONTROL PLATFORM

(71) Applicant: International Business Machines Corporation, Armonk, NY (US)

(72) Inventors: Wen WANG, Hai Dian District (CN); Kun Yan YIN, NINGBO (CN); Yi Chen ZHONG, Shanghai (CN); Chao DONG, Ningbo (CN)

(21) Appl. No.: 19/059,254

(22) Filed: Feb. 20, 2025

(51) Int. Cl. G06T 17/00; G06T 7/20; G06T 7/70; G06V 10/25; G06V 20/70; G06V 40/20

(52) U.S. Cl. CPC G06T 17/00; G06T 7/20; G06T 7/70; G06V 10/25; G06V 20/70; G06V 40/28

(57) ABSTRACT

Annotated data comprising video data and audio data is obtained from an extended reality (XR) device, wherein the annotated data is associated with a quality inspection operation. At least one annotation caption indicative of a defect is detected based on the annotated data. At least one annotation interval is determined based on the at least one annotation caption, the at least one annotation interval comprising at least one of a video interval or an audio interval. Tagged data is generated by tagging the at least one of the video interval or the audio interval based on the annotation caption. The tagged data is transmitted to a data store to facilitate presentation, by an output component of a computing device, of a representation of the tagged data.

### BACKGROUND

The present invention relates to extended reality, and in particular to an extended reality quality control platform.

Augmented, Virtual and Mixed Reality are the technologies collectively refer to as Extended Reality (XR). These transformative technologies are powered by artificial intelligence (AI), connected to the Internet of Things (IoT), and delivered through the cloud and integrated into systems. When augmented reality meets augmented intelligence, it has the potential to change the way users work, learn, shop and share ideas.

### SUMMARY

In one embodiment, a computer-implemented method is provided. In this embodiment, the method includes obtaining annotated data from an extended reality (XR) device, the annotated data comprising video data and audio data, wherein the annotated data is associated with a quality inspection operation. The method further includes detecting, based on the annotated data, at least one annotation caption indicative of a defect. Additionally, the method includes determining at least one annotation interval based on the at least annotation caption, the at least one annotation interval comprising at least one of a video interval or an audio interval. The method also includes generating tagged data by tagging the at least one of the video interval or the audio interval based on the annotation caption. Finally, the method includes transmitting the tagged data to a data store to facilitate presentation, by an output component of a computing device, a representation of the tagged data.

In another embodiment, a computer system is provided. In this embodiment, the computer system comprises one or more computer-readable storage media, a processor set, and program instructions stored on the one or more computer-readable storage media to cause the processor set to perform operations. The operations include obtaining annotated data from an XR device, the annotated data comprising video data and audio data, wherein the annotated data is associated with a quality inspection operation. The operations further include detecting, based on the annotated data, at least one annotation caption indicative of a defect. Additionally, the operations include determining at least one annotation interval based on the at least annotation caption, the at least one annotation interval comprising at least one of a video interval or an audio interval. The operations also include generating tagged data by tagging the at least one of the video interval or the audio interval based on the annotation caption. Finally, the operations include transmitting the tagged data to a data store to facilitate presentation, by an output component of a computing device, a representation of the tagged data.

In yet another embodiment, a computer program product is provided. In this embodiment, the computer program product comprises one or more computer-readable storage media and program instructions stored on the one or more computer readable storage media to perform operations. The operations include obtaining annotated data from an XR device, the annotated data comprising video data and audio data, wherein the annotated data is associated with a quality inspection operation. The operations further include detecting, based on the annotated data, at least one annotation caption indicative of a defect. Additionally, the operations include determining at least one annotation interval based on the at least annotation caption, the at least one annotation interval comprising at least one of a video interval or an audio interval. The operations also include generating tagged data by tagging the at least one of the video interval or the audio interval based on the annotation caption. Finally, the operations include transmitting the tagged data to a data store to facilitate presentation, by an output component of a computing device, a representation of the tagged data.

### BRIEF DESCRIPTION OF THE DRAWINGS

FIG. 1A is a block diagram of an example system for providing quality control services using extended reality (XR), as described herein.

FIG. 1B is a block schematic diagram of an example data flow associated with the system of FIG. 1A.

FIG. 2A is a block schematic diagram of an example data flow associated with an audio processing component, as described herein.

FIG. 2B is a block schematic diagram of an example data flow associated with a video processing component, as described herein.

FIG. 3A is a diagram of an annotated data example, as described herein.

FIG. 3B is a diagram of an annotated data example, as described herein

FIG. 4 is a diagram of an example associated with annotation interval determination, as described herein.

FIG. 5 is a diagram of an example associated with gesture tracking for tagging a video annotation interval, as described herein.

FIG. 6 is a block diagram of an example computing environment in which systems and/or methods described herein may be implemented.

FIG. 7 is a diagram of example components of one or more devices of FIG. 1A.

FIG. 8 is a flowchart of an example technique for facilitating a quality control process using extended reality, as described herein.

### DETAILED DESCRIPTION

The following detailed description of example implementations refers to the accompanying drawings. The same reference numbers in different drawings may identify the same or similar elements.

In the realm of quality control and inspection processes, extended reality (XR) technologies have emerged as tools for enhancing efficiency and accuracy. These technologies, which include augmented reality (AR), virtual reality (VR), or MR, offer the potential to change how inspections are conducted across various industries. However, the integration of XR into quality control workflows presents technical challenges, particularly in the realm of data collection, annotation, and analysis.

One of the technical hurdles in XR-based quality control systems is the efficient capture and processing of multimodal data. Current systems often struggle to simultaneously record and annotate both visual and audio information in real-time during an inspection process. This limitation stems from the complexity of synchronizing diverse data streams and the computational demands of processing high-fidelity XR environments. Moreover, the accurate detection and segmentation of defects within the captured data pose difficulties, especially when dealing with subtle audio cues or visually complex environments.

Another challenge lies in the automated extraction and tagging of relevant information from the captured XR data. Existing solutions frequently require manual intervention to identify and label defects, leading to time-consuming post-processing steps and potential inconsistencies in annotation. This manual approach not only reduces the overall efficiency of the quality control process but also introduces the possibility of human error, particularly when dealing with large volumes of inspection data. Furthermore, the lack of standardized methods for annotating and categorizing defects in XR environments hinders the development of robust machine learning models for automated defect detection and classification.

The seamless integration of XR-based inspection data with existing quality control systems and databases presents yet another technical obstacle. Many current implementations struggle to effectively translate the rich, immersive data captured during XR inspections into formats that are compatible with traditional quality management systems. This incompatibility often results in data silos, where valuable inspection insights remain isolated from broader quality control processes and analytics. Additionally, the real-time transmission and storage of high-fidelity XR data pose challenges in terms of network bandwidth and data storage requirements, particularly in industrial environments with limited connectivity or storage capabilities.

Implementations of this disclosure address problems such as these by obtaining annotated data from an XR device, detecting annotation captions indicative of defects, determining annotation intervals, generating tagged data, and transmitting the tagged data to facilitate presentation. As used herein, the term “extended reality (XR) device” may refer to any device capable of capturing and annotating multimodal data in an augmented, virtual, or mixed reality environment. For example, an XR device may include AR glasses, a VR headset, or a smartphone with AR capabilities. Annotating data may refer to capturing multimodal data, in which one or more data modes (e.g., audio data, test data, etc.) may be referred to as annotations.

As used herein, the term “annotation” may refer to supplementary information associated with captured data in an XR environment. Annotations may include user-generated or system-generated content that provides additional context, highlights specific features, or indicates areas of interest within the captured data. In some implementations, annotations may include recorded data from an environment such as, for example, a noise associated with a defect in a product, machine, or service. In some aspects, annotations may comprise audio recordings, textual descriptions, visual markers, or gestures that are synchronized with the primary video or audio data. Annotations may be used to identify, describe, or categorize defects, anomalies, or points of interest during a quality inspection process. In some implementations, annotations may be automatically generated based on predefined criteria or machine learning algorithms, while in other instances, they may be manually created by a user interacting with the XR environment.

The disclosed implementations improve upon existing quality control processes by integrating XR technologies with automated data processing and annotation techniques. This technical solution involves real-time multimodal data capture, natural language processing, computer vision, and machine learning algorithms to enhance the efficiency and accuracy of quality inspections. In some implementations, the XR device may be equipped with cameras, microphones, and sensors to capture high-fidelity visual and audio data during an inspection process.

The term “annotated data” in this disclosure refers to multimodal data, including video and audio data, that contains user-generated annotations or captions indicating potential defects or areas of interest during a quality inspection operation. For example, annotated data may include a video stream of an industrial component with accompanying audio narration describing observed anomalies. In some implementations, additional data types such as thermal imaging, depth sensing, or haptic feedback data may be included.

In some implementations, a system may include an XR quality control platform configured to perform one or more of the techniques described herein. For example, the XR quality control platform may employ natural language processing (NLP) models to detect annotation captions from audio data. These models may include, but are not limited to, long short-term memory (LSTM) networks or large language models (LLMs). The NLP models may be trained to recognize domain-specific terminology and context related to quality inspection processes, improving the accuracy of defect detection and classification.

The disclosure introduces the concept of “annotation intervals,” which refer to specific segments of video or audio data that correspond to identified defects or areas of interest. For video data, an annotation interval may be determined through computer vision techniques, such as gesture recognition and tracking. In some implementations, the XR quality control platform may identify and track the movement of a user's hand or fingertip to define a region of interest within a video frame. For audio data, annotation intervals may be isolated using frequency analysis and audio smoothing techniques, such as moving average, median filtering, or Gaussian smoothing.

The process of generating tagged data involves associating relevant metadata with the identified annotation intervals. This metadata may include timestamps, defect type identifiers, or textual descriptions of the observed issues. In some implementations, the XR quality control platform may employ machine learning algorithms to extract and refine annotation tags, comparing them against predefined tag databases to ensure consistency and accuracy in defect classification.

The tagged data generated by the XR quality control platform represents a technical improvement over traditional quality control documentation methods. By leveraging XR technologies and automated data processing, the XR quality control platform creates rich, contextual records of inspection processes that can be easily stored, retrieved, and analyzed. This approach not only enhances the efficiency of individual inspections but also facilitates long-term trend analysis and predictive maintenance strategies.

In some implementations, the XR quality control platform may include additional features such as real-time feedback mechanisms, integration with existing quality management systems, or the ability to generate immersive 3D visualizations of tagged defects. These enhancements further demonstrate the technical advancements offered by the disclosed solution, providing a comprehensive and adaptable platform for next-generation quality control processes across various industries.

In some implementations, the XR quality control platform obtains annotated data from an XR device, including video data and audio data associated with a quality inspection operation. Accordingly, an advantage of obtaining annotated data from an XR device is the ability to capture rich, multimodal information about potential defects in real-time during inspections. Additionally, an advantage of obtaining annotated data from an XR device is the seamless integration of user observations and environmental data, enhancing the accuracy and context of defect identification. Furthermore, an advantage of obtaining annotated data from an XR device is the potential for hands-free operation, allowing inspectors to focus on their task without interruption to manually record observations.

In some implementations, the XR quality control platform detects annotation captions indicative of defects based on the annotated data using NLP models. Accordingly, an advantage of using NLP models for defect detection is the ability to automatically interpret and categorize user-generated annotations, reducing the need for manual processing. Additionally, an advantage of using NLP models for defect detection is the potential for improved accuracy in identifying defects across various domains and industries by leveraging domain-specific terminology and context. Furthermore, an advantage of using NLP models for defect detection is the scalability of the system, allowing it to handle large volumes of inspection data efficiently.

In some implementations, the XR quality control platform determines annotation intervals including video or audio intervals based on the detected annotation captions. Accordingly, an advantage of determining annotation intervals is the precise isolation of relevant data segments containing defect information, streamlining subsequent analysis and review processes. Additionally, an advantage of determining annotation intervals is the ability to create time-synchronized records of defects across multiple data modalities, enhancing the comprehensiveness of quality control documentation. Furthermore, an advantage of determining annotation intervals is the potential for more efficient storage and retrieval of inspection data by focusing on pertinent segments rather than entire recordings.

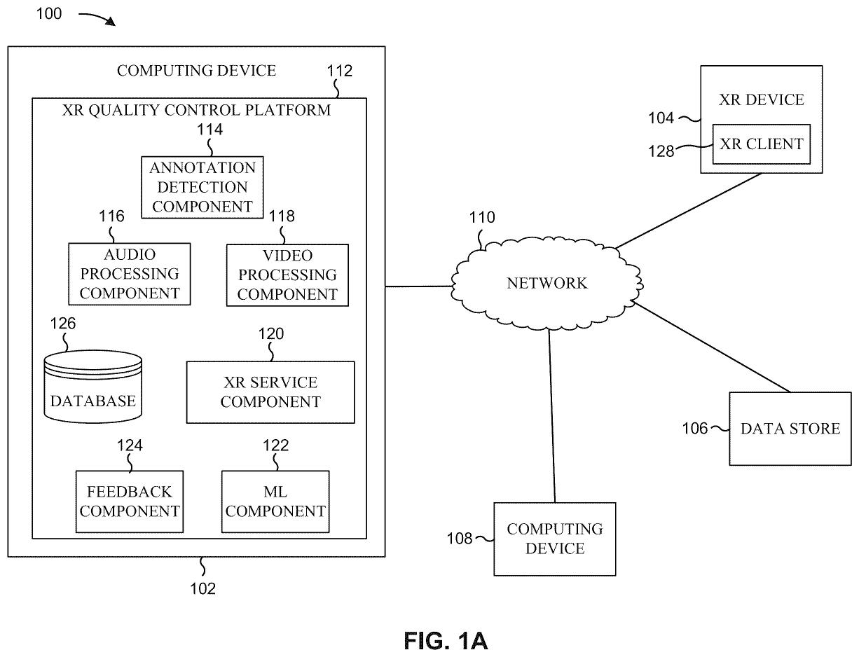

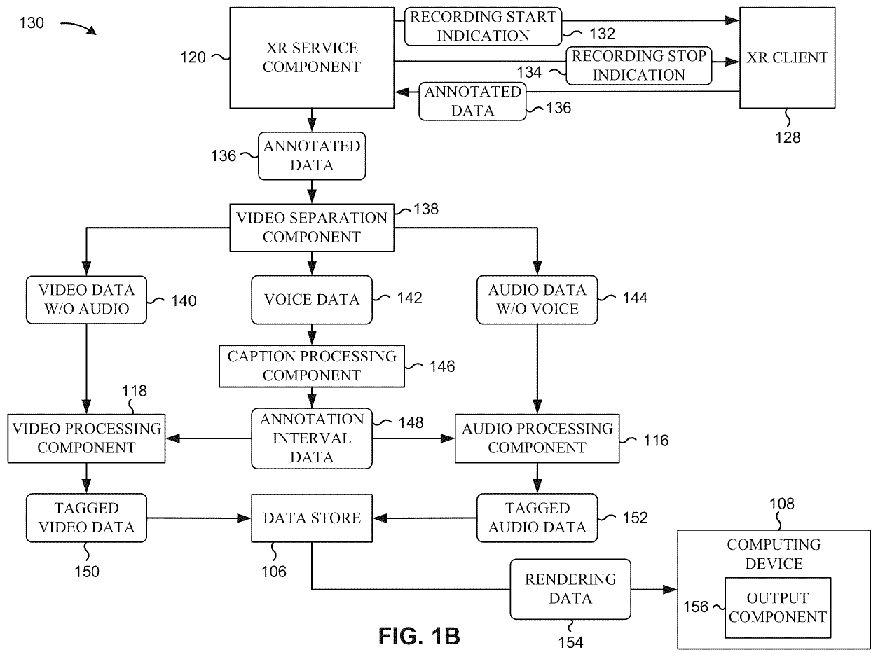

FIG. 1A is a block diagram of an example system 100 for processing XR data. As shown, the system 100 includes a computing device 102, an XR device 104, a data store 106, a computing device 108, and a network 110, communicatively coupled to facilitate data exchange and processing operations. The system 100 may be implemented using various hardware environments that include computer system components, such as general-purpose computers, dedicated computer systems, peripheral devices, and modules. In some implementations, the system 100 may be executed within one or more cloud computing environments, where various components may be executed in different configurations, including in parallel. In some implementations, one or more components of the system 100 can be implemented using a single computing device or a combination of several interconnected computing devices.

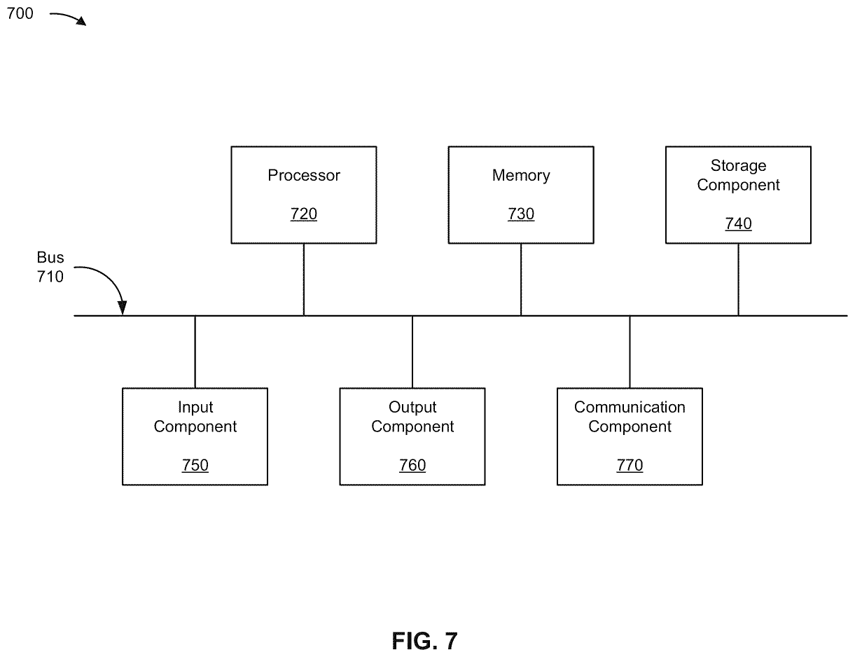

While the various components of FIG. 1A are shown separately within the system 100, one or more components shown in FIG. 1A may be combined. In some implementations, one or more components of FIG. 1A (e.g., one or both of the computing devices 102 and 108, the XR device 104, or the data store 106) may include one or more devices (e.g., the device 700 of FIG. 7). One or more components of FIG. 1A (e.g., the computing devices 102 and 108, the XR device 104, or the data store 106) may be implemented within the computing environment 600 as nodes of a distributed computing system (e.g., the cloud computing 605 or 606 described below). Alternatively or additionally, one or more components of FIG. 1A (e.g., the computing devices 102 and 108, the XR device 104, or the data store 106) may include machine-executable code resident in one or more memories or other computer-readable storage media for execution by one or more processors.

The computing device 102 includes an XR quality control platform 112, which includes multiple processing components arranged to handle different aspects of XR data processing. In some implementations, the XR quality control platform 112 may be a software application, a hardware module, or a combination of software and hardware. The platform 112 may be configured to process and analyze XR data collected during quality inspection operations.

The XR quality control platform 112 includes an annotation detection component 114, an audio processing component 116, a video processing component 118, an XR service component 120, a machine learning (ML) component 122, a feedback component 124, and a database 126. In some implementations, one or more of the components of the platform 112 can be implemented using a single computing device or a combination of several interconnected computing devices. In some implementations, two or more of the components of the platform 112 (e.g., the machine learning component 122) may be integrated into a single component or module.

The annotation detection component 114 may be configured to facilitate detection of annotation captions from audio data, such as that associated with a quality inspection operation. In some implementations, the annotation detection component 114 may be configured to extract audio data and video data from annotated data received at the computing device 102 from an XR device 104 (e.g., via the XR service component 120). The audio data may be captured via a microphone of the XR device 104 and the video data may be captured via a camera of the XR device 104 (or via a camera associated with the computing device 102), for example. In some implementations, the annotation detection component 114 may be configured to associate the annotated data with a user account of the XR device 104, for example, to facilitate tracking of defects and quality inspections.

In some implementations, the annotation detection component 114 may include the audio processing component 116 and the video processing component 118. In some implementations, the annotation detection component 114 may be communicatively coupled to the audio processing component 116 and the video processing component 118. The annotation detection component 114 may be configured to use the audio processing component 116 and the video processing component 118 to facilitate detection of annotation captions from the audio data or the video data, respectively. The annotation detection component 114, the audio processing component 116, or the video processing component 118 may include or be communicatively coupled to the machine learning component 122. The machine learning component 122 may include one or more machine learning models, algorithms, or functions, as described within this disclosure.

Machine learning refers generally to the ability of a computer program to learn without being explicitly programmed. In some instances, machine learning explores the study and construction of algorithms, also referred to herein as tools, that may learn from existing data and make predictions about new data. Such machine-learning tools operate by building a model from example training data in order to make data-driven predictions or decisions expressed as outputs or assessments. Although example implementations are presented with respect to a few machine-learning tools, the principles presented herein may be applied to other machine-learning tools.

In some instances, different machine-learning tools may be used. For example, Logistic Regression (LR), Naive-Bayes, Random Forest (RF), neural networks (NN), matrix factorization, and Support Vector Machines (SVM) tools may be used for classifying or scoring records based on the training data. The machine learning component 122 may utilize one or a combination of these example techniques, depending on the type of information used in the annotated data and the type of assessment and analysis that is desired. In some implementations, the machine learning component 122 may be configured to train, refine, or retrain a machine learning model, algorithm, or function, in accordance with aspects of this disclosure. For example, the machine learning component 122 may utilize training techniques including, but not limited to, supervised learning, unsupervised learning, semi-supervised learning, or reinforcement learning.

The annotation detection component 114 and/or the audio processing component 116 may be configured to process audio data captured using the XR device 104. In some implementations, the audio processing component 116 may be configured to analyze audio data to determine one or more annotation captions within the audio data. For example, the audio processing component 116 may be configured to analyze audio data to determine whether the audio data includes one or more annotation captions. For example, the audio processing component 116 may be configured to use a voice recognition model to analyze the audio data and determine whether the audio data includes one or more annotation captions. In some implementations, the audio processing component 116 may be configured to apply one or more NLP techniques to one or more annotation captions to determine the presence of one or more annotation captions within audio data. In some implementations, the audio processing component 116 may be configured to apply a machine learning model to analyzed audio data to determine the presence of one or more annotations within audio data. In some implementations, the audio processing component 116 may be configured to generate tagged data including the analyzed audio data and one or more annotation captions, the audio data being tagged as corresponding to, including, or including one or more annotation captions.

In some implementations, the audio processing component 116 may be configured to identify one or more annotation intervals associated with audio data corresponding to the audio data. For example, the audio processing component 116 may be configured to analyze audio data to identify one or more annotation intervals. In some implementations, the audio processing component 116 may analyze audio amplitude data and/or audio frequency data to identify one or more annotation intervals. For example, the audio processing component 116 may be configured to use machine learning models to analyze audio amplitude data and/or audio frequency data and identify one or more annotation intervals based on audio amplitude data and/or audio frequency data. In some implementations, the audio processing component 116 may refine one or more annotation intervals after identification of the annotation intervals within the audio data. For example, the audio processing component 116 may be configured to use one or more audio smoothing techniques to refine one or more annotation intervals identified within audio data.

The annotation detection component 114 and/or the video processing component 118 may be configured to process video data captured using the XR device 104. In some implementations, the video processing component 118 may be configured to analyze video data captured by the XR device 104 to determine one or more annotation captions within the video data. For example, the video processing component 118 may be configured to analyze video data to determine whether the video data includes one or more annotation captions. In some implementations, the video processing component 118 may be configured to detect one or more user gestures in the video data to determine whether the video data includes one or more annotation captions. A gesture may refer to a movement by one or more of a user's hands, arms, head, or body, or a combination thereof, for example. In some implementations, the video processing component 118 may be configured to generate tagged data associated with the video data, for example, in response to detecting a gesture in the video data.

The XR service component 120 may be configured to provide an interface between the XR quality control platform 112 and the XR device 104. In some implementations, the XR service component 120 may be configured to receive annotated data from the XR device 104 and forward the received annotated data to the annotation detection component 114. For example, the XR service component 120 may be configured to receive audio data and video data from the XR device 104 and forward the received video data and audio data to the audio processing component 116 and the video processing component 118, respectively. The XR service component 120 may include, for example, an application programming interface (API) configured to facilitate communication or data transfer between the computing device 102 and the XR device 104. In some implementations, the XR service component 120 may be configured to perform one or more functions to facilitate communication between the computing device 102 and the XR device 104. For example, the XR service component 120 may be configured to convert data received from the XR device 104 into a format usable by the XR quality control platform 112, the annotation detection component 114, the audio processing component 116, or the video processing component 118.

The feedback component 124 may be configured to obtain feedback data associated with one or more quality inspection operations in association with the computing device 102. In some implementations, the feedback component 124 may receive feedback data from the XR device 104. For example, the feedback component 124 may be configured to receive feedback data via an API associated with the XR service component 120. The feedback data may include, for example, feedback signals received from the XR device 104, user input received from the XR device 104, or sensor data received from the XR device 104.

The feedback data received at the feedback component 124 may include feedback associated with the quality inspection operation and/or the annotated data received from the XR device 104. In some implementations, the feedback data may include information indicating one or more of an operational anomaly, a deficiency, an omission, a flaw, or a failure associated with one or more of the annotated data or the quality inspection operation of the computing device 102. For example, in response to receiving feedback data, the feedback component 124 may be configured to update or modify information (e.g., a quality inspection report) associated with the XR quality control platform 112 or one or more of the annotation detection component 114, the audio processing component 116, the video processing component 118, the XR service component 120, or the database 126. In some implementations, the feedback data may be used by the machine learning component 122 to refine, retrain, or re-train one or more machine learning models used by one or more of the annotation detection component 114, the audio processing component 116, or the video processing component 118.

The database 126 may be configured to store data, for example, data communicated or provided by the XR quality control platform 112. In some implementations, the database 126 may be integrated within the computing device 102. In some implementations, the database 126 may be remote from the computing device 102. The database 126 may include, for example, a hard drive, a memory, or a database hosted by a server. The database 126 may be configured to store data associated with the XR quality control platform 112 and/or the computing device 102. In some implementations, the database 126 may store, for example, one or more of annotated data, audio data, video data, annotation captions, annotation intervals, tagged data, user account information, or feedback data. The database 126 may be implemented using a single memory or multiple memories. The database 126 may include one or more databases of different types such as, for example, relational databases, hierarchical databases, navigational databases, in-memory databases, flat not only structured memory or a combination thereof

The XR device 104 includes an XR client 128, which may be a software application or a combination of software and hardware components that enable the XR device to interact with the XR quality control platform 112. In some implementations, the XR device 104 may be an AR headset, a VR headset, or an MR device capable of capturing and annotating multimodal data during quality inspection operations. The XR client 128 may be configured to interface with the XR service component 120 to facilitate XR operations by the XR device.

The network 110 serves as the communication medium between components, enabling data flow and coordination of processing tasks. The network 110 may include one or more wired or wireless networks including, for example, a Personal Area Network (PAN), a Local Area Network (LAN), a Metropolitan Area Network (MAN), a Wide Area Network (WAN), a Storage Area Network (SAN), a Campus Area Network (CAN), a Virtual Private Network (VPN), an enterprise private network, the Internet, or a combination thereof, for example. In some implementations, the network 110 may include a cellular network, a public land mobile network (PLMN), and/or a satellite network. The network 110 may be configured to communicatively couple the computing device 102 with the XR device 104, the data store 106, and/or the computing device 108.

The data store 106 may be configured to store data for the XR quality control platform 112. For example, the data store 106 may be configured to store data communicated or provided by one or more of the annotation detection component 114, the audio processing component 116, the video processing component 118, the XR service component 120, or the database 126. In some implementations, the data store 106 may be integrated within the computing device 102. In some implementations, the data store 106 may be remote from the computing device 102. The data store 106 may include, for example, a hard drive, a memory, or a database hosted by a server. The data store 106 may be configured to store data associated with the XR quality control platform 112 and/or the computing device 102. In some implementations, the data store 106 may store, for example, one or more of annotated data, audio data, video data, annotation captions, annotation intervals, tagged data, user account information, or feedback data. The data store 106 may be implemented using a single memory or multiple memories. The data store 106 may include one or more databases of different types such as, for example, relational databases, hierarchical databases, navigational databases, in-memory databases, flat not only structured memory or a combination thereof.

The computing device 108 may be a workstation, a laptop, or another type of computer system used by quality control personnel to review and analyze the processed XR data. In some implementations, the computing device 108 may be any type of computing device such as, for example, the device 700 described with regard to FIG. 7 or the computing environment 600 described with regard to FIG. 7. In some implementations, the computing device 108 may include specialized hardware or software for rendering XR environments and visualizing defect information. In some implementations, the computing device 108 may be configured to receive data (e.g., tagged data) from the computing device 102 via the network 110.

FIG. 1B illustrates a block diagram of an example data flow 130 associated with the system 100 of FIG. 1A. The data flow 130 demonstrates the process of capturing, processing, and analyzing XR data during a quality inspection operation.

The XR service component 120 initiates the data collection process by sending a recording start indication 132 to the XR client 128. This indication may be triggered automatically based on predefined inspection schedules or manually by a quality control operator. In some implementations, the recording start indication 132 may include parameters such as the duration of the recording, specific areas to focus on, or particular defect types to look for. In some implementations, a recording start indication 132 may be omitted such as, for example, where the XR client 128 determines a recording start time or a user of the XR client 128 provides user input to cause the recording process to start.

Once the recording process is complete, the XR service component 120 sends a recording stop indication 134 to the XR client 128. In response, the XR client 128 provides annotated data 136 to the XR quality control platform 112. The annotated data 136 may include video footage of an inspected item (e.g., a machine, a product, or a process), audio recordings of the inspector's observations, audio recordings of sounds associated with the inspected item, and any additional metadata captured during the inspection process. In some implementations, a recording stop indication 134 may be omitted such as, for example, where the XR client 128 determines a recording stop time or a user of the XR client 128 provides user input to cause the recording process to stop.

In response to the recording stop indication 134, the XR client 128 provides annotated data 136 to the XR quality control platform. The annotated data 136 may include video footage of an inspected item (e.g., a machine, a product, or a process), audio recordings of the inspector's observations, audio recordings of sounds associated with the inspected item, and any additional metadata captured during the inspection process. In some implementations, the annotated data 136 may be transmitted in real-time during the inspection process, while in other implementations, it may be sent as a batch after the inspection is complete.

The data flow 130 includes a video separation component 138, which may be configured to process the annotated data 136 and separate it into different data streams. In some implementations, the video separation component 138 may extract video data without audio 140 from the annotated data 136. This video data without audio 140 may include the visual information captured during the inspection process, such as images or video frames of the inspected item or area. In some implementations, the video separation component 138 may be included in the annotation detection component 114 shown in FIG. 1A.

The video separation component 138 may also extract human voice data 142 from the annotated data 136. In some implementations, the human voice data 142 may include verbal annotations or observations made by the inspector during the quality control operation. This data may be used for identifying and understanding potential defects or areas of concern noted by the inspector.

Additionally, the video separation component 138 may extract audio data without human voice 144 from the annotated data 136. In some implementations, this audio data without human voice 144 may include ambient sounds, machine noises, or other audio cues that could be indicative of defects or issues in the inspected item or process. The separation of these different audio streams allows for more targeted analysis of each type of audio data.

The data flow 130 includes a caption processing component 146, which may be configured to process the human voice data 142 and generate annotation interval data 148. In some implementations, the caption processing component 146 may employ natural language processing (NLP) techniques to transcribe and analyze the verbal annotations made by the inspector. The annotation interval data 148 may include time-stamped segments of the inspection process where potential defects or issues were noted.

The caption processing component 146 may employ various techniques to process the human voice data 142 and generate annotation interval data 148. In some implementations, the caption processing component 146 may utilize speech recognition algorithms to convert the audio data into text transcripts. These transcripts may then be analyzed using NLP techniques to identify phrases, technical terms, or specific descriptors that indicate potential defects or areas of concern. The caption processing component 146 may leverage ML models, such as recurrent neural networks or transformer-based models, to understand the context and intent behind the inspector's verbal annotations. This analysis may help in accurately identifying and categorizing different types of defects or issues mentioned during the inspection process.

In some aspects, the caption processing component 146 may be included as part of the annotation detection component 114. This integration may allow for more seamless coordination between audio and video data processing, enabling the system to correlate verbal annotations with corresponding visual information. The caption processing component 146 may work in conjunction with other subcomponents of the annotation detection component 114 to provide a comprehensive analysis of the inspection data. For instance, it may synchronize the processed verbal annotations with timestamp information from the video data, allowing for localization of noted defects or issues within the overall inspection timeline. The caption processing component 146 may generate annotation interval data 148 based on the processed human voice data 142. This annotation interval data 148 may include time-stamped information about potential defects or areas of interest identified through the verbal annotations of the inspector.

The data flow 130 also includes components for processing the separated data streams. A video processing component 118 may be configured to analyze the video data without audio 140 and generate tagged image data 150. In some implementations, the video processing component 118 may employ computer vision techniques to identify visual defects or areas of interest in the video frames. The tagged image data 150 may include visual markers or annotations highlighting potential issues identified in the video data.

In some implementations, the video processing component 118 may utilize the annotation interval data 148 to guide its analysis of the video data without audio 140. By correlating the time-stamped annotations with the corresponding video frames, the video processing component 118 may focus its computer vision algorithms on specific temporal segments or spatial regions of the video data that are more likely to contain defects or issues. This targeted approach may enhance the efficiency and accuracy of the visual defect detection process. In some implementations, the video processing component 118 may incorporate the information from the annotation interval data 148 into the generated tagged image data 150, providing a more comprehensive representation of the identified issues that combines both visual and verbal observations from the inspection process.

The video processing component 118 may employ a variety of computer vision techniques to analyze the video data without audio 140. In some implementations, the component may utilize convolutional neural networks (CNNs) to detect and classify visual defects or anomalies in the video frames. The CNNs may be trained on large datasets of annotated inspection images to recognize common defect patterns across different types of products or machinery. In some implementations, the video processing component 118 may incorporate object detection algorithms to identify specific components or regions of interest within the video frames, allowing for more targeted defect analysis.

In some implementations, the video processing component 118 may implement temporal analysis techniques to track changes or movements across multiple frames. This approach may help identify intermittent defects or issues that may not be apparent in a single frame. The video processing component 118 may utilize image segmentation algorithms to isolate and analyze specific areas or features within each frame. Once potential defects or areas of interest are identified, the video processing component 118 may generate tagged image data 150 by overlaying visual markers, bounding boxes, or color-coded highlights on the relevant portions of the video frames. These visual annotations may be accompanied by metadata describing the nature of the detected issues, their severity, and their location within the inspected item or area.

An audio processing component 116 may be included in the data flow 130 to analyze the audio data without human voice 144, using the annotation interval data 148, and generate tagged audio data 152. In some implementations, the audio processing component 116 may use signal processing techniques or machine learning models to identify unusual sounds or acoustic patterns that could indicate defects or malfunctions. The tagged audio data 152 may include timestamps and classifications of detected audio anomalies.

The audio processing component 116 may employ various signal processing and machine learning techniques to analyze the audio data without human voice 144. In some implementations, the audio processing component 116 may utilize spectral analysis methods, such as Fast Fourier Transform (FFT) or wavelet transforms, to decompose the audio signals into their frequency components. This frequency-domain representation may allow for the detection of specific acoustic signatures associated with different types of defects or machinery malfunctions. The audio processing component 116 may incorporate time-domain analysis techniques, such as envelope detection or peak detection, to identify temporal patterns or anomalies in the audio data.

In some aspects, the audio processing component 116 may leverage the annotation interval data 148 to enhance its analysis capabilities. By aligning the processed audio data with the time-stamped annotations, the audio processing component 116 may focus its analysis on specific segments of the audio stream that correspond to noted areas of concern. This targeted approach may improve the efficiency and accuracy of the audio defect detection process. In some implementations, the audio processing component 116 may use the context provided by the annotation interval data 148 to fine-tune its machine learning models or adjust its detection thresholds, potentially leading to more precise identification of audio anomalies. The resulting tagged audio data 152 may include not only the detected acoustic anomalies but also correlations with the verbal annotations, providing a comprehensive representation of the audio-based defect information.

The tagged image data 150 and tagged audio data 152 may be transmitted to the data store 106 for storage and subsequent retrieval. In some implementations, the data store 106 may utilize a structured database system to organize and index the tagged data, allowing for efficient querying and retrieval based on various criteria such as timestamp, defect type, or inspection session identifier. The data store 106 may implement data compression techniques to optimize storage capacity while maintaining data integrity. When a request for inspection data is received, the data store 106 may process the stored tagged image and audio data to generate rendering data 154. This rendering data 154 may include a combination of visual and audio information, along with associated metadata, formatted for presentation on various output devices. In some implementations, the data store 106 may employ caching mechanisms to improve response times for frequently accessed data. The rendering data 154 may be customized based on user preferences or device capabilities, potentially including features such as interactive visualizations, synchronized playback of visual and audio annotations, or filtered views focusing on specific types of defects. In some implementations, the XR service component 120 may generate the rendering data 154 based on the tagged image data 150, tagged audio data 152, and annotation interval data 148. The rendering data 154 may include a comprehensive representation of the inspection results, combining visual, audio, and verbal annotation data in a format suitable for XR presentation.

An output component 156 of the computing device 108 may be configured to present the rendering data 154 to users. In some implementations, the output component 156 may include displays, speakers, or XR devices for visualizing and interacting with the inspection results. The output component 156 may provide various ways to view and analyze the tagged data, enabling quality control personnel to efficiently review and act upon the inspection findings.

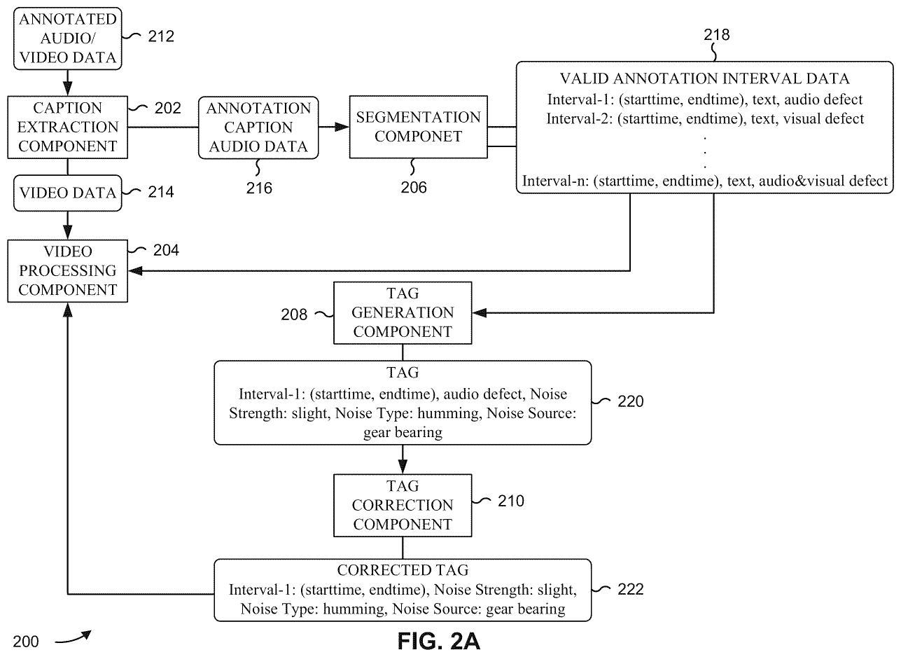

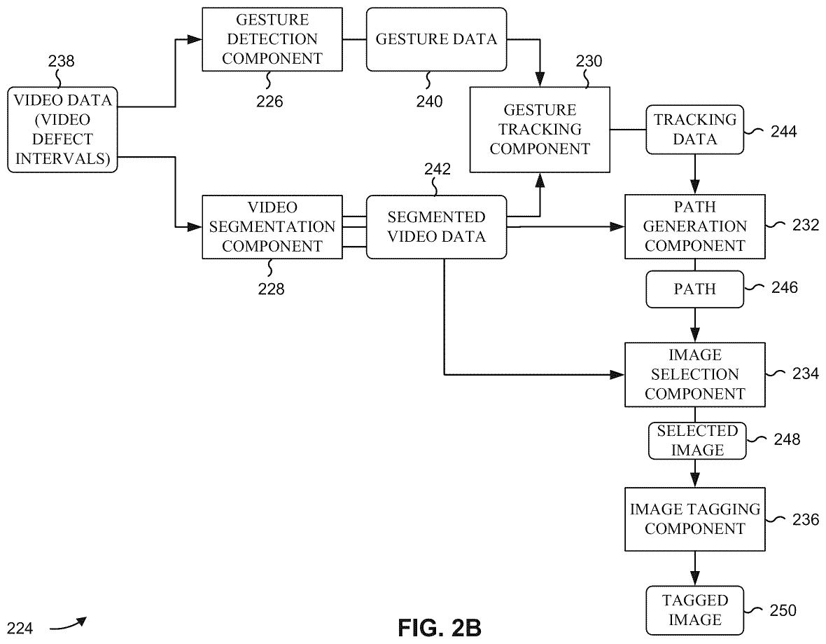

FIG. 2A illustrates a block diagram of an example data flow 200 for processing annotated audio and video data. The system receives annotated audio/video data 212 which is input to a caption extraction component 202. In some implementations, the annotated audio/video data 212 may be obtained from an XR device, such as an AR headset or smart glasses worn by a quality inspector during a quality control operation. The annotated audio/video data 212 may include synchronized audio and video streams captured by the XR device, along with user-generated annotations or captions indicating potential defects or areas of interest.

The caption extraction component 202 separates the input into video data 214 and annotation caption audio data 216. In some implementations, the caption extraction component 202 may employ speech recognition algorithms to transcribe spoken annotations into text, facilitating easier processing and analysis. The caption extraction component 202 may utilize various techniques to separate the audio and video streams, such as demultiplexing of multimedia containers or parsing of separate audio and video files.

The annotation caption audio data 216 flows to a segmentation component 206, which processes the audio data to generate valid annotation interval data 218. In some implementations, the segmentation component 206 may employ NLP techniques to identify relevant segments of the audio data that contain annotations or descriptions of potential defects. The segmentation component 206 may utilize various machine learning models, such as recurrent neural networks (RNNs) or transformer-based models, to accurately identify and extract annotation intervals from the continuous audio stream.

The valid annotation interval data 218 contains multiple intervals, including interval-1 with audio defect information, interval-2 with visual defect information, and interval-n with combined audio and visual defect information. In some implementations, each interval may be associated with metadata such as timestamps, duration, and defect type classification. The segmentation component 206 may employ various techniques to classify the type of defect associated with each interval, such as keyword spotting or semantic analysis of the transcribed audio content.

A tag generation component 208 receives the valid annotation interval data 218 and generates a tag 220. The tag 220 includes detailed information such as the interval timing, audio defect characteristics, noise strength, noise type, and noise source. In some implementations, the tag generation component 208 may utilize domain-specific knowledge bases or ontologies to standardize the terminology used in the tags. The tag generation component 208 may also employ machine learning techniques to extract relevant features from the audio data and generate more comprehensive and accurate tags.

The tag 220 is then processed by a tag correction component 210 which produces a corrected tag 222 containing refined defect information. In some implementations, the tag correction component 210 may compare the generated tags against a predefined database of known defects and their characteristics to ensure consistency and accuracy. The tag correction component 210 may also employ rule-based systems or machine learning models trained on historical quality control data to refine and validate the tags.

The video processing component 204 receives inputs from multiple sources: the video data 214 from the caption extraction component 202, the valid annotation interval data 218, and the corrected tag 222 from the tag correction component 210. In some implementations, the video processing component 204 may employ computer vision techniques to analyze the video content and identify visual defects or areas of interest. The video processing component 204 may utilize various deep learning models, such as convolutional neural networks (CNNs) or object detection networks, to process and analyze the video frames.

These inputs allow the video processing component 204 to process and analyze the video content in conjunction with the extracted and corrected annotation information. In some implementations, the video processing component 204 may synchronize the video frames with the audio annotations, allowing for precise localization of defects within the video stream. The video processing component 204 may also generate visual overlays or markers to highlight identified defects or areas of interest in the video frames.

FIG. 2B illustrates a block diagram of an example data flow 224 for processing video data with gesture detection. The system receives video data 238 containing video defect intervals as input, which flows to two parallel processing paths. In some implementations, the video data 238 may be captured by an XR device equipped with a camera, such as AR glasses or a smartphone with AR capabilities. The video data 238 may include footage of a product, machine, or process being inspected, along with the inspector's hand movements or gestures used to indicate areas of interest or potential defects.

In the first path, the video data 238 is processed by a gesture detection component 226 that outputs gesture data 240. In some implementations, the gesture detection component 226 may employ machine learning models, such as CNNs or pose estimation networks, to identify and classify various hand gestures or movements within the video frames. The gesture detection component 226 may be trained on a diverse dataset of gestures commonly used in quality inspection scenarios to ensure robust performance across different users and environments.

The gesture data 240 is then processed by a gesture tracking component 230 which generates tracking data 244. In some implementations, the gesture tracking component 230 may utilize computer vision techniques such as optical flow or Kalman filtering to track the movement of detected gestures across multiple video frames. The gesture tracking component 230 may also employ temporal models, such as LSTM networks, to analyze the sequence of gestures and infer more complex interactions or annotations.

In the second path, the video data 238 is processed by a video segmentation component 228 that produces segmented video data 242. In some implementations, the video segmentation component 228 may employ semantic segmentation techniques to divide the video frames into meaningful regions or objects. This segmentation may be based on various factors such as color, texture, or object boundaries. The video segmentation component 228 may utilize deep learning models, such as fully convolutional networks (FCNs) or U-Net architectures, to perform accurate and efficient segmentation of the video frames.

The segmented video data 242 feeds into both the gesture tracking component 230 and an image selection component 234. In some implementations, the segmented video data 242 may provide contextual information to improve the accuracy of gesture tracking and facilitate more precise localization of defects or areas of interest within the video frames.

The tracking data 244 from the gesture tracking component 230 flows to a path generation component 232 which creates a path 246. In some implementations, the path generation component 232 may use the tracked gesture data to construct a continuous path or trajectory that represents the inspector's annotation or highlighting of a defect area. The path generation component 232 may employ various curve fitting or smoothing techniques to create a refined and visually appealing path from the discrete tracked gesture points.

The path 246 is provided to the image selection component 234. In some implementations, the image selection component 234 may use the generated path to identify the relevant frame or set of frames from the video data that best represent the annotated defect or area of interest. The relevant frame or set of frames may be frames that are relevant beyond a predetermined threshold. The image selection component 234 may employ various criteria for frame selection, such as image quality, visibility of the defect, or absence of occlusions (e.g., the inspector's hand).

The image selection component 234 processes the segmented video data 242 and path 246 to select, from the video data, a selected image 248. In some implementations, the selected image 248 may be a single video frame or a composite image created from multiple frames to best represent the annotated defect or area of interest. The image selection component 234 may utilize image processing techniques such as frame averaging, super-resolution, or focus stacking to enhance the quality and clarity of the selected image.

The selected image 248 is then processed by an image tagging component 236 which generates a tagged image 250 as the final output. In some implementations, the image tagging component 236 may associate relevant metadata with the selected image, such as defect type, severity, location, and any textual annotations derived from the audio data or gesture analysis. The image tagging component 236 may also generate visual markers or overlays to highlight the defect area on the image, based on the path generated from the tracked gestures.

The components are arranged in a branching and merging configuration that enables parallel processing of gesture and video data while maintaining coordination through shared data flows. This architecture allows for efficient processing of the video data 238 through multiple stages to produce the tagged image 250 output. In some implementations, the system may employ parallel computing techniques or distributed processing to further optimize the performance of the video analysis and annotation pipeline.

In some implementations, the gesture detection component 226 may be configured to recognize a wider range of gestures or even full-body poses that could be relevant in certain quality inspection scenarios. For example, the system could be trained to recognize gestures indicating the scale or severity of a defect, or specific motions used to interact with large machinery or equipment during inspection.

The video segmentation component 228 may, in some implementations, incorporate additional contextual information or prior knowledge about the objects or environments typically encountered in quality inspection scenarios. This could involve the use of pre-trained models specific to certain industries or types of equipment, allowing for more accurate and meaningful segmentation of the video frames.

In some implementations, the path generation component 232 may employ more advanced trajectory prediction or smoothing algorithms to handle complex or discontinuous gestures. This could include the use of spline-based interpolation techniques or predictive models that can infer the intended path even when parts of the gesture are occluded or outside the camera's field of view.

The image selection component 234 may, in some implementations, utilize more sophisticated image quality assessment techniques to ensure that the selected frame or composite image provides a viewing clarity and informative view of the annotated defect beyond a predetermined threshold. This could involve the use of machine learning models trained to assess factors such as focus, lighting, and visibility of key features.

In some implementations, the image tagging component 236 may incorporate additional sources of contextual information to enrich the metadata associated with the tagged image. This could include integration with external databases containing product specifications, historical defect data, or maintenance records, allowing for more comprehensive and informative tagging of the identified defects or areas of interest.

The overall system architecture presented in FIGS. 2A and 2B allows for flexible and extensible processing of multimodal data in quality inspection scenarios. By leveraging advanced machine learning techniques and computer vision algorithms, the system can efficiently process and analyze complex audio-visual data streams, extracting relevant annotations and producing tagged outputs that can significantly enhance the efficiency and accuracy of quality control processes.

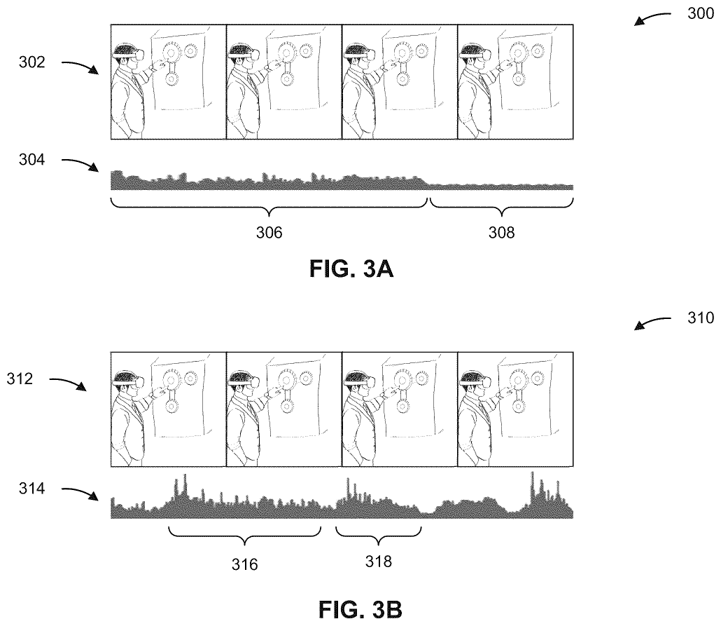

FIGS. 3A-3B are diagrams illustrating examples of annotated data associated with a quality inspection operation using an XR system such as, for example, the system 100 shown in FIG. 1A, in accordance with one or more implementations of the present disclosure.

FIG. 3A shows an example of annotated data 300 including video data 302 and corresponding audio data 304. The video data 302 includes a sequence of four video frames depicting a user wearing XR glasses and examining a machine. This sequence of frames represents a portion of a quality inspection operation being performed using an XR device.

Below the video data 302, the audio data 304 is represented as an audio waveform pattern. The audio data 304 is divided into two sections labeled as audio annotation 306 and audio annotation 308. Audio annotation 306 may correspond to a detected noise associated with the inspected component, while audio annotation 308 may represent an absence of detected noise. In some implementations, these annotations may be automatically generated by the XR device based on audio analysis algorithms, or they may be manually added by the user during the inspection process.

FIG. 3B illustrates another example of annotated data 310, which similarly includes video data 312 and corresponding audio data 314. The video data 312 presents another four-frame sequence of the same user performing an inspection.

The audio data 314 in FIG. 3B shows a distinctly different waveform pattern compared to FIG. 3A. This waveform contains more pronounced peaks and variations, particularly visible in sections labeled as audio annotation 316 and audio annotation 318. The higher amplitude and more irregular patterns in these sections suggest the detection of different types of sounds or anomalies during this portion of the inspection process.

In some implementations, the audio annotations 316 and 318 may correspond to user speech captured during the inspection. For example, the user may be verbally noting observations or potential defects while examining the component. These verbal annotations can provide valuable context for later analysis of the inspection data.

The consistent positioning and perspective maintained across the frames in both sequences allow for clear documentation of the inspection process while simultaneously recording the associated audio data. This synchronization between visual and audio data can be useful for comprehensive quality control analysis.

In some implementations, the XR device used to capture this annotated data may employ advanced audio processing techniques to isolate and enhance relevant sounds while suppressing background noise. This can help in more accurately identifying and annotating potential defects or anomalies based on their acoustic signatures. Some implementations may employ image stabilization techniques. This can be particularly useful in industrial environments where movement or vibrations might otherwise affect the quality of the captured video data. In some implementations, the XR device may utilize computer vision algorithms to automatically detect and highlight areas of interest within the video frames. For example, it may identify specific components or regions that require closer inspection based on predefined criteria or historical defect data.

The annotated data shown in FIGS. 3A and 3B can serve as input for further processing and analysis within the XR quality control platform. For example, machine learning models may be trained on this type of multimodal data to improve automated defect detection and classification in future inspections.

In some implementations, the video data 302 and 312 may include additional overlays or augmented reality elements not visible in these figures. These could include real-time measurements, component identification labels, or visual indicators of detected anomalies, enhancing the user's ability to perform thorough and accurate inspections.

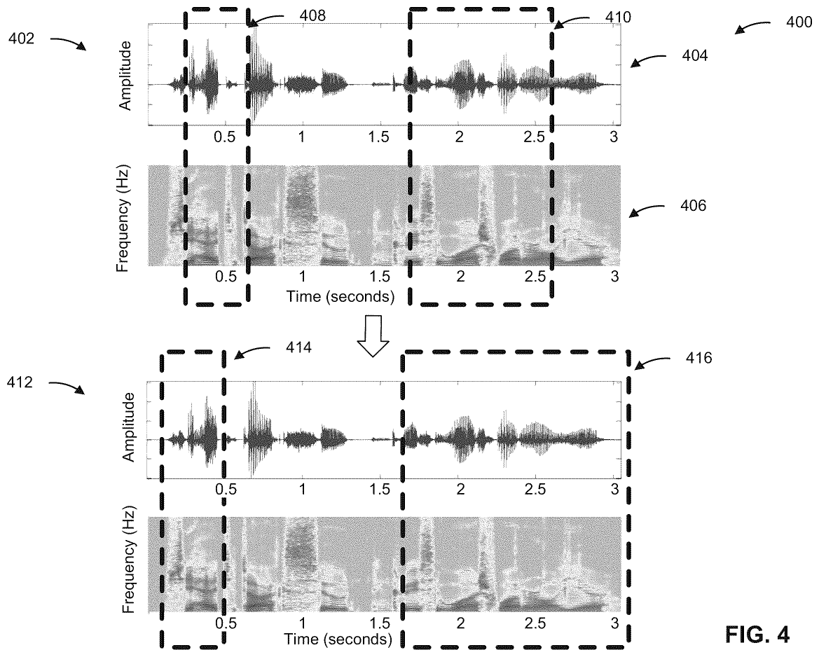

FIG. 4 is a diagram of an example 400 showing audio interval detection and refinement scenarios associated with processing annotated data from an XR device. The example 400 includes an interval detection scenario 402 and an interval refinement scenario 412, which illustrate techniques for identifying and refining annotation intervals within audio data captured during a quality inspection operation.

In some implementations, the interval detection scenario 402 may be performed by an audio processing component, such as the audio processing component 116 described in relation to FIG. 1A. The interval detection scenario 402 displays audio amplitude data 404 and audio frequency data 406 over a 3-second time period. The audio amplitude data 404 may represent the volume or intensity of the audio signal over time, while the audio frequency data 406 may represent the spectral content of the audio signal.

Within the interval detection scenario 402, a first annotation interval 408 is identified between 0.5-1 seconds, and a second annotation interval 410 is identified between 2-2.5 seconds. In some implementations, these annotation intervals may be determined based on analysis of the audio data using various signal processing techniques. For example, the audio processing component may employ threshold-based detection, energy-based segmentation, or machine learning models trained to identify potential defect-related sounds within the audio stream.

The identification of annotation intervals may involve analyzing both the audio amplitude data 404 and the audio frequency data 406. In some implementations, changes in amplitude or distinctive frequency patterns may be indicative of defect-related sounds or user annotations. For instance, an increase in amplitude coupled with specific frequency characteristics might suggest the presence of an abnormal noise associated with a mechanical defect.

In some implementations, the audio processing component may utilize domain-specific knowledge to enhance the accuracy of interval detection. For example, in an automotive quality inspection scenario, the system may be trained to recognize the typical frequency ranges and amplitude patterns associated with various types of engine or component defects.

The interval refinement scenario 412 demonstrates a subsequent processing step where the initially detected annotation intervals are further refined to more precisely capture the relevant audio segments. In this scenario, a first refined annotation interval 414 and a second refined annotation interval 416 are marked to more accurately represent the portions of the audio data containing potential defect information or user annotations.

The refinement process may involve various audio processing techniques to improve the precision of the detected intervals. In some implementations, the audio processing component may apply audio smoothing techniques to reduce noise and more clearly delineate the boundaries of the annotation intervals. These smoothing techniques may include, but are not limited to, moving average filters, median filtering, or Gaussian smoothing.

Moving average filters may be used to reduce short-term fluctuations in the audio signal, helping to identify more stable regions that correspond to sustained defect-related sounds. Median filtering may be applied to remove sporadic noise or outliers in the audio data, potentially improving the accuracy of interval boundary detection. Gaussian smoothing may be employed to create a weighted average of neighboring data points, which can help in identifying gradual transitions between normal and defect-related audio segments. These smoothing techniques (and/or others) may be applied individually or in combination, depending on the specific characteristics of the audio data and the nature of the defects being detected. The refined intervals resulting from these smoothing processes may provide a more precise representation of the relevant audio segments, potentially improving the accuracy of subsequent defect analysis and classification tasks.

In some implementations, the refinement process may also incorporate more advanced signal processing methods, such as adaptive thresholding or dynamic time warping, to account for variations in audio characteristics across different inspection environments or equipment types. This adaptability can be useful in scenarios where the quality inspection operations are conducted in diverse settings with varying acoustic properties.

The refined annotation intervals 414 and 416 may serve as input for subsequent processing steps within the XR quality control platform. For example, these refined intervals may be used to extract specific audio features, generate text transcriptions of user annotations, or synchronize the audio data with corresponding video frames for a comprehensive multimodal analysis of the inspection data.

In some implementations, the audio processing component may employ machine learning models, such as CNNs or RNNs, to further improve the accuracy of interval detection and refinement. These models may be trained on large datasets of annotated inspection audio to learn complex patterns and relationships that may not be apparent through traditional signal processing techniques alone.

The interval detection and refinement process illustrated in FIG. 4 may be performed in real-time or near-real-time as the annotated data is received from the XR device. This capability can enable prompt feedback to inspectors during the quality control operation, potentially allowing for immediate reinspection or additional data collection if certain audio cues suggest the presence of a defect that requires further investigation.

In some implementations, the audio processing component may consider contextual information when performing interval detection and refinement. For example, the system may take into account the specific type of equipment being inspected, the stage of the inspection process, or even environmental factors that might influence the audio characteristics. This contextual awareness can help improve the relevance and accuracy of the detected annotation intervals.

The techniques illustrated in FIG. 4 may be applied iteratively or in combination with other data processing methods to continuously improve the quality and reliability of the annotation interval detection. For instance, the results of the audio interval analysis may be cross-referenced with video data or textual annotations to provide a more comprehensive understanding of the inspection process and any identified defects.

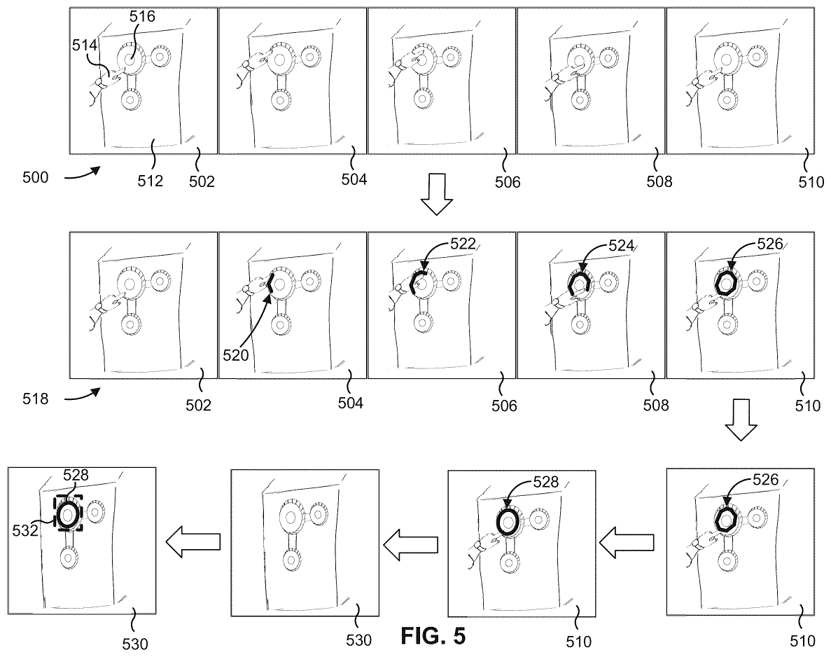

FIG. 5 illustrates a flowchart depicting a process for video annotation and gesture tracking. The process is shown using a video annotation intervals 500. The video annotation interval 500 includes a sequence of video frames 502, 504, 506, 508, and 510 showing a machine 512 and a user hand 514 pointing to a gear bearing 516 of the machine 512. In some implementations, the machine 512 may represent an industrial component or equipment undergoing quality inspection. The gear bearing 516 may be a specific area of interest or a potential location for defects.

FIG. 5 shows an example 518 of a gesture tracking operation using the sequence of video frames 502, 504, 506, 508, and 510. In this interval, gesture track portions 520, 522, and 524 are recorded across the frames, forming a gesture track 526 that traces the movement of the user hand 514. In some implementations, the gesture tracking may be performed using computer vision algorithms, such as optical flow or feature tracking methods, to follow the movement of the user's hand across consecutive frames.

The process continues with a sequence of frames showing the transformation of the tracked gesture into a final annotated image. The gesture track 526 is used by a video processing component (e.g., the video processing component 118 shown in FIGS. 1A and 1B to generate a path 528 in frame 510. In some implementations, this generation may involve smoothing or interpolation techniques to create a continuous path from the discrete tracked points. The path 528 may represent the area of interest or the location of a potential defect as indicated by the user's gesture.

The video processing component may, based on the path 528, select a selected frame 530, which includes the machine 512 without the user hand 514. In some implementations, this frame selection process may involve analyzing multiple frames to choose the one that provides the view of the area of interest without occlusions from the user's hand. The view may a view that is clear beyond a predetermined threshold. This selection may be based on various criteria such as image clarity, visibility of the potential defect, or absence of motion blur.

As shown, a bounding box 532 is drawn around the area indicated by path 528. In some implementations, the bounding box 532 may be automatically generated based on the gesture path, using algorithms to determine the optimal size and position of the box to encompass the area of interest. The bounding box 532 serves to highlight and isolate the potential defect or area of concern for further analysis.

In some implementations, the illustrated process may include additional steps for processing the annotated image. For example, the video processing component may apply image enhancement techniques to the area within the bounding box 532 to improve visibility of potential defects. This could involve adjusting contrast, applying filters, or using advanced image processing algorithms to highlight specific features or anomalies.

In some implementations, this process may be performed in real-time or near-real-time, allowing for immediate feedback to the inspector during the quality control operation. In some implementations, the process may be executed as a post-processing step, allowing for more computationally intensive analysis techniques to be applied.

In some implementations, the video processing component may incorporate machine learning models to assist in the gesture recognition and defect identification process. For example, a CNN could be trained on a dataset of common gestures used in quality inspection scenarios, improving the accuracy and robustness of the gesture tracking component. Similarly, another machine learning model could be employed to analyze the area within the bounding box 532, comparing it against a database of known defects to provide automated defect classification or severity assessment.

In some implementations, the video processing component may provide additional interaction modalities beyond hand gestures. For example, voice commands could be integrated to allow the user to provide verbal descriptions or classifications of observed defects. These voice annotations could be processed using speech recognition algorithms and associated with the corresponding visual annotations, providing a multimodal approach to defect documentation.

The process illustrated in FIG. 5 represents an advancement in quality inspection methodologies by leveraging XR technologies. By enabling intuitive, gesture-based annotation of potential defects, the video processing component can enhance the efficiency and accuracy of quality control operations. The automated tracking, frame selection, and bounding box generation steps demonstrate how computer vision techniques can be applied to streamline the documentation process, potentially reducing the time and effort required for manual annotation while improving the consistency and detail of inspection records.

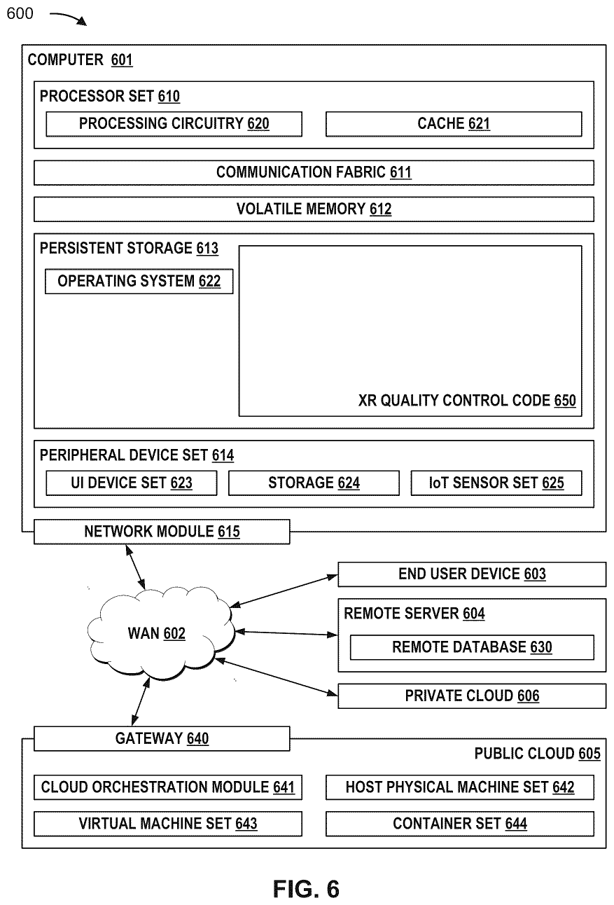

FIG. 6 is a diagram of an example computing environment 600 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as XR quality control code, shown in block 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. In some implementations, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

FIG. 7 is a diagram of example components of a device 700, which may implement one or more components of the system 100. As shown in FIG. 7, device 700 may include a bus 710, a processor 720, a memory 730, a storage component 740, an input component 750, an output component 760, and a communication component 770.

Bus 710 includes a component that enables wired and/or wireless communication among the components of device 700. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform a function. Memory 730 includes a random access memory, a read only memory, and/or another type of memory (e.g., a flash memory, a magnetic memory, and/or an optical memory).

Storage component 740 stores information and/or software related to the operation of device 700. For example, storage component 740 may include a hard disk drive, a magnetic disk drive, an optical disk drive, a solid state disk drive, a compact disc, a digital versatile disc, and/or another type of non-transitory computer-readable medium. Input component 750 enables device 700 to receive input, such as user input and/or sensed inputs. For example, input component 750 may include a touch screen, a keyboard, a keypad, a mouse, a button, a microphone, a switch, a sensor, a global positioning system component, an accelerometer, a gyroscope, and/or an actuator. Output component 760 enables device 700 to provide output, such as via a display, a speaker, and/or one or more light-emitting diodes. Communication component 770 enables device 700 to communicate with other devices, such as via a wired connection and/or a wireless connection. For example, communication component 770 may include a receiver, a transmitter, a transceiver, a modem, a network interface card, and/or an antenna.

Device 700 may perform one or more processes described herein. For example, a non-transitory computer-readable medium (e.g., memory 730 and/or storage component 740) may store a set of instructions (e.g., one or more instructions, code, software code, and/or program code) for execution by processor 720. Processor 720 may execute the set of instructions to perform one or more processes described herein. In some implementations, execution of the set of instructions, by one or more processors 720, causes the one or more processors 720 and/or the device 700 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or In some implementations, a set of components (e.g., one or more components) of device 700 may perform one or more functions described as being performed by another set of components of device 700.

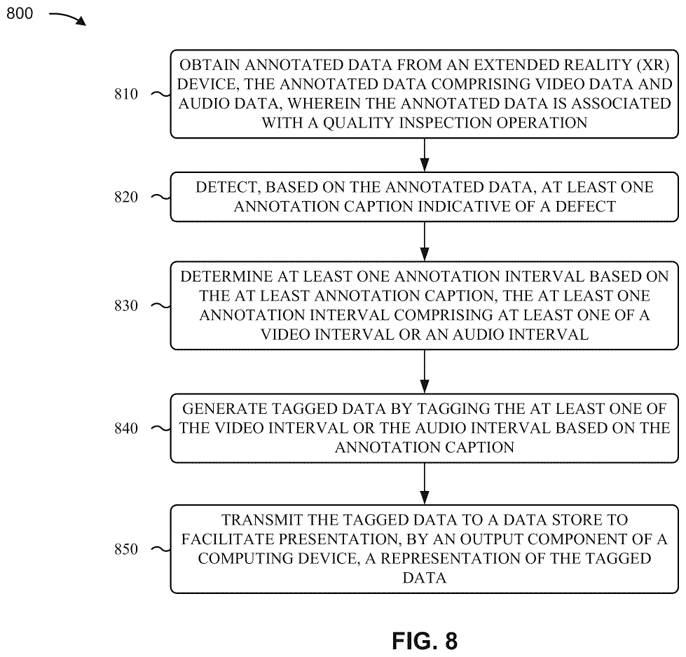

To further describe some implementations in greater detail, reference is next made to examples of techniques which may be performed by or using the XR quality control platform as described herein. FIG. 8 is a flowchart of an example of a technique associated with processing annotated data from an XR device. The technique 800 can be executed using computing devices, such as the systems, hardware, and software described with respect to FIGS. 1A-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations of the technique 800 can occur in various orders and/or concurrently. Additionally, other steps or operations not presented and described herein may be used. Furthermore, not all illustrated steps or operations may be required to implement a technique in accordance with the disclosed subject matter.

At 810, the technique 800 includes obtaining annotated data from an XR device, the annotated data including video data and audio data, wherein the annotated data is associated with a quality inspection operation. For example, an XR quality control platform (e.g., the XR quality control platform 112 shown in FIG. 1A) may receive annotated data from an XR device (e.g., the XR device 104 shown in FIG. 1A) through an XR service component (e.g., the XR service component 120 shown in FIG. 1A). In some implementations, the annotated data may include video footage of an inspected item, audio recordings of an inspector's observations, and audio recordings of sounds associated with the inspected item.

At 820, the technique 800 includes detecting, based on the annotated data, at least one annotation caption indicative of a defect. In some implementations, an annotation detection component (e.g., the annotation detection component 114 shown in FIG. 1A) may analyze the audio data to determine one or more annotation captions within the audio data. For example, the annotation detection component may use a voice recognition model to analyze the audio data and determine whether the audio data includes one or more annotation captions. In some implementations, the annotation detection component may apply one or more NLP techniques to one or more annotation captions to determine the presence of one or more annotation captions within audio data. In some implementations, a video processing component (e.g., the video processing component 118 shown in FIG. 1A) may analyze video data to detect one or more user gestures indicative of an annotation caption.

At 830, the technique 800 includes determining at least one annotation interval based on the at least one annotation caption, the at least one annotation interval including at least one of a video interval or an audio interval. In some implementations, an audio processing component (e.g., the audio processing component 116 shown in FIG. 1A) may analyze audio amplitude data and/or audio frequency data to identify one or more annotation intervals. For example, the audio processing component may use machine learning models to analyze audio amplitude data and/or audio frequency data and identify one or more annotation intervals based on audio amplitude data and/or audio frequency data. In some implementations, the audio processing component may refine one or more annotation intervals after identification of the annotation intervals within the audio data using one or more audio smoothing techniques, such as moving average, median filtering, or Gaussian smoothing.

At 840, the technique 800 includes generating tagged data by tagging the at least one of the video interval or the audio interval based on the annotation caption. In some implementations, a video processing component (e.g., the video processing component 118 shown in FIG. 1A) may generate tagged data associated with the video data in response to detecting a gesture in the video data. For example, the video processing component may identify a path by tracking a movement of a user's hand in the video data, draw the path on a frame of the video data, select a representative image frame from the video data without the presence of the hand, and draw a bounding box around a defect location based on the path. In some implementations, tagging may involve associating at least one tag with the at least one annotation interval, the tag being indicative of a defect characteristic identified from the at least one annotation.

At 850, the technique 800 includes transmitting the tagged data to a data store to facilitate presentation, by an output component of a computing device, a representation of the tagged data. For example, the XR quality control platform may transmit the tagged data to a data store (e.g., the data store 106 shown in FIG. 1A) for storage and subsequent retrieval. In some implementations, the data store may output rendering data to a computing device (e.g., the computing device 108 shown in FIG. 1A) for presentation of the tagged data.

In some implementations, the technique 800 may include additional steps or variations of the described steps. For example, the technique may include extracting at least one annotation tag from the at least one annotation interval. This extraction may be performed using an LLM in some implementations. Additionally, the technique may include correcting the at least one tag by comparing the at least one tag with a predefined tag database based on a similarity calculation.

In some implementations, the detection of annotation captions may involve determining a defect type including at least one of an audio defect or a video defect. The detection process may utilize various machine learning models, such as LSTM models or LLMs, to analyze the audio data and identify potential defects or areas of interest.

The tagged data generated by the technique 800 may include various types of metadata in some implementations. This metadata may include, but is not limited to, timestamps, defect type identifiers, or text associated with the defect. Such metadata can provide valuable context and information for subsequent analysis and review of the quality inspection data.

In some implementations, the technique 800 may incorporate advanced gesture recognition capabilities. For example, when detecting user gestures in the video data, the system may employ a trained gesture recognition model capable of identifying complex hand movements or even full-body poses that could be relevant in certain quality inspection scenarios. This could allow for more nuanced and detailed annotations of potential defects or areas of interest during the inspection process.

The technique 800 may also include steps for real-time feedback in some implementations. For example, the XR quality control platform could process incoming data on-the-fly and provide immediate alerts or guidance to inspectors through the XR device if potential defects are detected. This real-time capability could reduce inspection times and improve overall quality control effectiveness.

According to an aspect of the disclosure, there is provided a computer-implemented method. The method includes obtaining annotated data from an XR device. The annotated data comprises video data and audio data, and is associated with a quality inspection operation. The method detects at least one annotation caption indicative of a defect based on the annotated data. The method determines at least one annotation interval based on the annotation caption. The annotation interval comprises at least one of a video interval or an audio interval. The method generates tagged data by tagging the video interval or the audio interval based on the annotation caption. The method transmits the tagged data to a data store to facilitate presentation of a representation of the tagged data by an output component of a computing device. This method improves the efficiency and accuracy of quality inspection processes by leveraging XR technologies and automated data processing. Additionally, the method enhances the documentation of quality control operations by generating rich, contextual records that can be easily stored, retrieved, and analyzed.

In embodiments, determining the annotation caption can include detecting at least one user command based on the audio data and an NLP model. This has the technical effect of automatically interpreting and categorizing user-generated annotations, reducing the need for manual processing. Additionally, this approach improves the accuracy of defect identification across various domains by leveraging domain-specific terminology and context.

In embodiments, determining the annotation caption can include detecting a gesture of the user based on the video data and a trained gesture recognition model. This has the technical effect of enabling intuitive, gesture-based annotation of potential defects, enhancing the efficiency of quality control operations. Additionally, this approach allows for hands-free operation, enabling inspectors to focus on their task without interruption.

In embodiments, detecting the gesture can include identifying a location of a fingertip of the user in the video data and tracking a movement of the fingertip. This has the technical effect of precisely capturing user-indicated areas of interest or potential defects. Additionally, this approach enables more accurate and detailed annotations in the quality inspection process.

In embodiments, determining the annotation interval can include isolating an interval containing a defect sound by performing a frequency analysis on the audio data. This has the technical effect of automatically identifying and extracting relevant audio segments associated with potential defects. Additionally, this approach enhances the accuracy of defect detection by focusing on specific acoustic signatures.

In embodiments, performing the frequency analysis can include refining the isolated audio interval by performing an audio smoothing technique. The audio smoothing technique can comprise at least one of a moving average technique, a median filtering technique, or a Gaussian smoothing technique. This has the technical effect of improving the precision of detected audio intervals by reducing noise and more clearly delineating the boundaries of annotation intervals. Additionally, this approach enhances the quality of extracted audio data for subsequent analysis.

In embodiments, determining the annotation interval can include segmenting the video data to isolate a frame corresponding to a defect location identified by the annotation. This has the technical effect of precisely isolating visual information related to potential defects. Additionally, this approach facilitates more efficient review and analysis of inspection results by focusing on relevant video segments.

In embodiments, segmenting the video data can further include generating a bounding box around the defect location. This has the technical effect of visually highlighting and isolating areas of interest or potential defects within the video frames. Additionally, this approach enhances the clarity and focus of defect documentation in the quality inspection process.

In embodiments, tagging the video interval or the audio interval can include associating at least one tag with the annotation interval. The tag is indicative of a defect characteristic identified from the annotation. This has the technical effect of creating structured, machine-readable metadata associated with detected defects. Additionally, this approach facilitates more efficient storage, retrieval, and analysis of inspection data.

In embodiments, tagging the video interval or the audio interval can further include correcting the tag by comparing the tag with a predefined tag database based on a similarity calculation. This has the technical effect of improving the consistency and accuracy of defect classification across multiple inspections. Additionally, this approach enhances the reliability of the quality control documentation by standardizing the terminology used in defect descriptions.

According to an aspect of the disclosure, there is provided a computer system. The system includes one or more computer-readable storage media, a processor set, and program instructions stored on the computer-readable storage media. The program instructions cause the processor set to perform operations including obtaining annotated data from an XR device, detecting at least one annotation caption indicative of a defect, determining at least one annotation interval, generating tagged data, and transmitting the tagged data to a data store. This system improves the efficiency and accuracy of quality inspection processes by automating the capture, processing, and analysis of multimodal inspection data. Additionally, the system enhances the integration of XR technologies with existing quality control workflows, enabling more comprehensive and detailed defect documentation.

In embodiments, detecting the annotation caption can include determining a defect type comprising at least one of an audio defect or a video defect. This has the technical effect of categorizing detected defects based on their sensory modality, enabling more targeted analysis and remediation strategies. Additionally, this approach facilitates the development of specialized processing techniques for different types of defects.

In embodiments, detecting the annotation caption can include analyzing the audio data using at least one of an LSTM model or an LLM. This has the technical effect of leveraging advanced machine learning techniques to interpret complex audio annotations and context. Additionally, this approach improves the system's ability to understand and process natural language descriptions of defects.

In embodiments, the operations can further include extracting at least one annotation tag from the annotation interval. This has the technical effect of automatically generating structured metadata from unstructured annotation data. Additionally, this approach enhances the searchability and analyzability of the inspection data.

In embodiments, extracting the annotation tag can include extracting the annotation tag using an LLM. This has the technical effect of leveraging advanced natural language processing capabilities to accurately interpret and categorize complex annotations. Additionally, this approach improves the system's ability to handle diverse and domain-specific terminology in quality inspection scenarios.

In embodiments, the tagged data can comprise metadata including at least one of a timestamp, a defect type identifier, or text associated with the defect. This has the technical effect of enriching the inspection data with contextual information for more comprehensive analysis. Additionally, this approach facilitates more efficient searching, filtering, and reporting of quality control issues.

According to an aspect of the disclosure, there is provided a computer program product. The product includes one or more computer-readable storage media and program instructions stored on the computer-readable storage media. The program instructions perform operations including obtaining annotated data from an XR device, detecting at least one annotation caption indicative of a defect, determining at least one annotation interval, generating tagged data, and transmitting the tagged data to a data store. This product improves the efficiency and accuracy of quality inspection processes by providing a software solution for automated processing of XR-based inspection data. Additionally, the product enhances the scalability and consistency of quality control operations across different inspection scenarios and environments.

In embodiments, determining the annotation interval can include extracting an annotated audio range and identifying an annotated audio interval by performing an audio smoothing technique in association with at least one acoustic feature. The acoustic feature can comprise at least one of an energy feature, a pitch feature, a spectral centroid feature, or a spectral bandwidth feature. This has the technical effect of precisely isolating relevant audio segments associated with potential defects using advanced signal processing techniques. Additionally, this approach improves the accuracy of defect detection by analyzing multiple acoustic characteristics.

In embodiments, detecting the annotation caption can include detecting a user gesture in the video data using a trained gesture recognition model. The user gesture can comprise a gesture by a hand of the user that indicates a defect location. This has the technical effect of enabling intuitive and precise annotation of visual defects through natural hand movements. Additionally, this approach enhances the user experience during quality inspections by allowing for more natural and efficient interaction with the XR system.

In embodiments, generating the tagged data can include identifying a path by tracking a movement of the hand in the video data, drawing the path on a frame of the video data, selecting a representative image frame from the video data without the presence of the hand, and drawing a bounding box around the defect location based on the path on the representative image frame. This has the technical effect of creating clear and accurate visual representations of annotated defects. Additionally, this approach improves the quality of defect documentation by providing both the original gesture path and a clean, hand-free image of the defect area.

In one implementation, the XR quality control platform effectively enhances the inspection process in an automotive manufacturing environment. When a quality control inspector wearing AR glasses examines a vehicle's engine compartment, the system captures both visual and audio data in real-time. As the inspector notices a slight humming noise coming from the skylight, they verbally annotate this observation. The XR quality control platform's audio processing component, utilizing advanced frequency analysis and audio smoothing techniques, isolates this specific sound and tags it as a potential defect. Simultaneously, the video processing component tracks the inspector's hand gestures as they point to a visible gap in the upper storage board. The system automatically generates a bounding box around this area in the video frame, creating a visual annotation of the defect. This multimodal approach to data collection and annotation significantly reduces the time required for defect documentation and improves the accuracy of the inspection process.

In another scenario, the XR quality control platform demonstrates its versatility in a precision manufacturing setting. An inspector using the system examines a complex machinery assembly line. As they move through the inspection, they use both voice commands and hand gestures to indicate areas of concern. The platform's natural language processing capabilities interpret the inspector's verbal annotations, such as “strong noise coming from the upper storage board,” and associate them with the corresponding video frames. Concurrently, the gesture recognition model tracks the inspector's hand movements, allowing them to precisely outline irregularities in component alignment or surface finish. The system then processes this multimodal input to generate comprehensive tagged data, including timestamps, defect type identifiers, and precise spatial information. This tagged data is immediately transmitted to a central database, where it can be accessed by quality control managers for rapid decision-making and trend analysis, significantly enhancing the overall efficiency of the quality control process.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
obtaining annotated data from an extended reality (XR) device, the annotated data comprising video data and audio data, wherein the annotated data is associated with a quality inspection operation;
detecting, based on the annotated data, at least one annotation caption indicative of a defect;
determining at least one annotation interval based on the at least annotation caption, the at least one annotation interval comprising at least one of a video interval or an audio interval;
generating tagged data by tagging the at least one of the video interval or the audio interval based on the annotation caption; and
transmitting the tagged data to a data store to facilitate presentation, by an output component of a computing device, a representation of the tagged data.

2. The computer-implemented method of claim 1, wherein determining the at least one annotation caption comprises detecting at least one user command based on the audio data and a natural language processing (NLP) model.

3. The computer-implemented method of claim 1, wherein determining the at least one annotation caption comprises detecting, based on the video data and a trained gesture recognition model, a gesture of a user.

4. The computer-implemented method of claim 3, wherein detecting the gesture comprises:
identifying a location of a fingertip of the user in the video data; and
tracking a movement of the fingertip.

5. The computer-implemented method of claim 1, wherein determining the at least one annotation interval comprises isolating an interval containing a defect sound by performing a frequency analysis on the audio data.

6. The computer-implemented method of claim 5, wherein performing the frequency analysis comprises refining the isolated interval by performing an audio smoothing technique, the audio smoothing technique comprising at least one of moving average technique, a median filtering technique, or a Gaussian smoothing technique.

7. The computer-implemented method of claim 1, determining the at least one annotation interval comprises segmenting the video data to isolate a frame corresponding to a defect location identified by the at least one annotation.

8. The computer-implemented method of claim 7, wherein segmenting the video data further comprises generating a bounding box around the defect location.

9. The computer-implemented method of claim 1, wherein tagging the at least one of the video interval or the audio interval comprises associating at least one tag with the at least one annotation interval, the tag being indicative of a defect characteristic identified from the at least one annotation.

10. The computer-implemented method of claim 9, tagging the at least one of the video interval or the audio interval further comprises correcting the at least one tag by comparing the at least one tag with a predefined tag database based on a similarity calculation.

11. A computer system, comprising:
one or more computer-readable storage media;
a processor set; and
program instructions stored on the one or more computer-readable storage media to cause the processor set to perform operations comprising:
obtaining annotated data from an extended reality (XR) device, the annotated data comprising video data and audio data, wherein the annotated data is associated with a quality inspection operation;
detecting, based on the annotated data, at least one annotation caption indicative of a defect;
determining at least one annotation interval based on the at least one annotation caption, the at least one annotation interval comprising at least one of a video interval or an audio interval;
generating tagged data by tagging the at least one of the video interval or the audio interval based on the annotation caption; and
transmitting the tagged data to a data store to facilitate presentation, by an output component of a computing device, a representation of the tagged data.

12. The computer system of claim 11, wherein detecting the at least one annotation caption comprises:
determining a defect type comprising at least one of an audio defect or a video defect.

13. The computer system of claim 11, wherein detecting the at least one annotation caption comprises analyzing the audio data using at least one of a long short-term memory (LSTM) model or a large language model (LLM).

14. The computer system of claim 11, further comprising extracting at least one annotation tag from the at least one annotation interval.

15. The computer system of claim 14, wherein extracting the at least one annotation tag comprises extracting the at least one annotation tag using a large language model (LLM).

16. The computer system of claim 11, wherein the tagged data comprises metadata including at least one of a timestamp, a defect type identifier, or text associated with the defect.

17. A computer program product comprising:
one or more computer-readable storage media; and
program instructions stored on the one or more computer-readable storage media to perform operations comprising:
obtaining annotated data from an extended reality (XR) device, the annotated data comprising video data and audio data, wherein the annotated data is associated with a quality inspection operation;
detecting, based on the annotated data, at least one annotation caption indicative of a defect;
determining at least one annotation interval based on the at least one annotation caption, the at least one annotation interval comprising at least one of a video interval or an audio interval;
generating tagged data by tagging the at least one of the video interval or the audio interval based on the annotation caption; and
transmitting the tagged data to a data store to facilitate presentation, by an output component of a computing device, a representation of the tagged data.

18. The computer program product of claim 17, wherein determining the at least one annotation interval comprises:
extracting an annotated audio range; and
identifying an annotated audio interval by performing an audio smoothing technique in association with at least one acoustic feature, the at least one acoustic feature comprising at least one of an energy feature, a pitch feature, a spectral centroid feature, or a spectral bandwidth feature.

19. The computer program product of claim 17, wherein detecting the at least one annotation caption comprises detecting a user gesture in the video data using a trained gesture recognition model, the user gesture comprising a gesture by a hand of the user that indicates a defect location.

20. The computer program product of claim 19, wherein generating the tagged data comprises:
identifying a path by tracking a movement of the hand in the video data;
drawing the path on a frame of the video data;
selecting a representative image frame from the video data, wherein the representative image frame is selected as a frame without a presence of the hand; and
drawing, on the representative image frame, a bounding box around the defect location based on the path.
